(19) United States
(12) Patent Application Publication
(10) Pub. No.: US 2017/0045174 A1
(43) Pub. Date: Feb. 16, 2017

(54) MANUAL LOADING VALVE FOR LIVE GAS LINE

(71) Applicant: Robert Daniel Crawford, Covington, GA (US)

(72) Inventor: Robert Daniel Crawford, Covington, GA (US)

(21) Appl. No.: 15/233,307

(22) Filed: Aug. 10, 2016

Related U.S. Application Data
(60) Provisional application No. 62/203,242, filed on Aug. 10, 2015.

(51) Int. Cl. F16L 55/07; F16L 55/26

(52) U.S. Cl. CPC F16L 55/07; F16L 55/26

(57) ABSTRACT

A valve assembly for attaching to a live gas line at the shut off, so as to insert a camera cable into the open line through the valve assembly, while the live line is sealed off.

### CROSS-REFERENCE TO RELATED APPLICATION

This application claims the benefit of priority of U.S. provisional application No. 62/203,242, filed 10 Aug. 2015, the contents of which are herein incorporated by reference.

### BACKGROUND OF THE INVENTION

The present invention relates to gas line inspection valve assemblies and, more particularly, to a valve assembly that may be inserted into a live line at the shut off, so as to insert a camera cable into the open line, while the live line is sealed off.

The internal inspection of live gas lines is a prudent way of maintaining a safe and effective gas line. Typically, such inspection is done by snaking a camera through the line in order to see the internal portion of line connections and intersections. Such an internal inspection process, however, is fraught with the risk of inadvertently releasing gas from the line.

As can be seen, there is a need for a valve assembly that may be inserted into a live line at the shut off, so as to insert a camera cable into the open line, while the live line is sealed off.

### SUMMARY OF THE INVENTION

In one aspect of the present invention, a valve assembly that may be inserted into a live line at the shut off, so as to insert a camera cable into the open line, while the live line is sealed off, includes an elongated main housing extending from a threaded end to a skirt, wherein the skirt provides a threaded internal circumference; a bushing providing a bushing opening having a diameter less than a diameter of the threaded internal circumference; a seal providing a seal opening having a diameter less than the diameter of the bushing opening; and an adjusting knob providing a threaded body terminating in a circumferential flange, wherein the threaded body is dimensioned to mate with the threaded internal circumference so that the circumferential flange sandwiches the seal against the bushing, while sandwiching the bushing along a periphery of the threaded internal circumference, the seal, bushing, threaded internal circumference and the circumferential flange being concentrically disposed.

In another aspect of the present invention, the valve assembly includes an elongated main housing extending from a threaded end to a skirt, wherein the skirt provides a threaded internal circumference; a bushing providing a bushing opening having a diameter less than a diameter of the threaded internal circumference, wherein the bushing is two halves; a seal providing a seal opening having a diameter less than the diameter of the bushing opening; an adjusting knob providing a threaded body terminating in a circumferential flange, wherein the threaded body is dimensioned to mate with the threaded internal circumference so that the circumferential flange sandwiches the seal against the bushing, while sandwiching the bushing along a periphery of the threaded internal circumference, the seal, bushing, threaded internal circumference and the circumferential flange being concentrically disposed, wherein the adjusting knob is two joined halves, and wherein each half of the circumferential flange halves provides aligned through holes; a plurality of fasteners for joining the aligned through holes; and a support collar dimensioned to snugly slide along the elongated body, wherein the support collar provides opposing brackets, each bracket rotatably connecting a securing leg to the support collar, wherein rotation of either of the securing legs secures the support collar along the elongated body, and wherein each securing leg terminates in threading.

These and other features, aspects and advantages of the present invention will become better understood with reference to the following drawings, description and claims.

### BRIEF DESCRIPTION OF THE DRAWINGS

FIG. 1 is a top perspective view of an exemplary embodiment of the present invention;

FIG. 2 is a bottom perspective view of an exemplary embodiment of the present invention; and

FIG. 3 is an exploded view of an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a valve assembly that may be inserted into a live line at the shut off, so as to insert a camera cable into the open line, while the live line is sealed off.

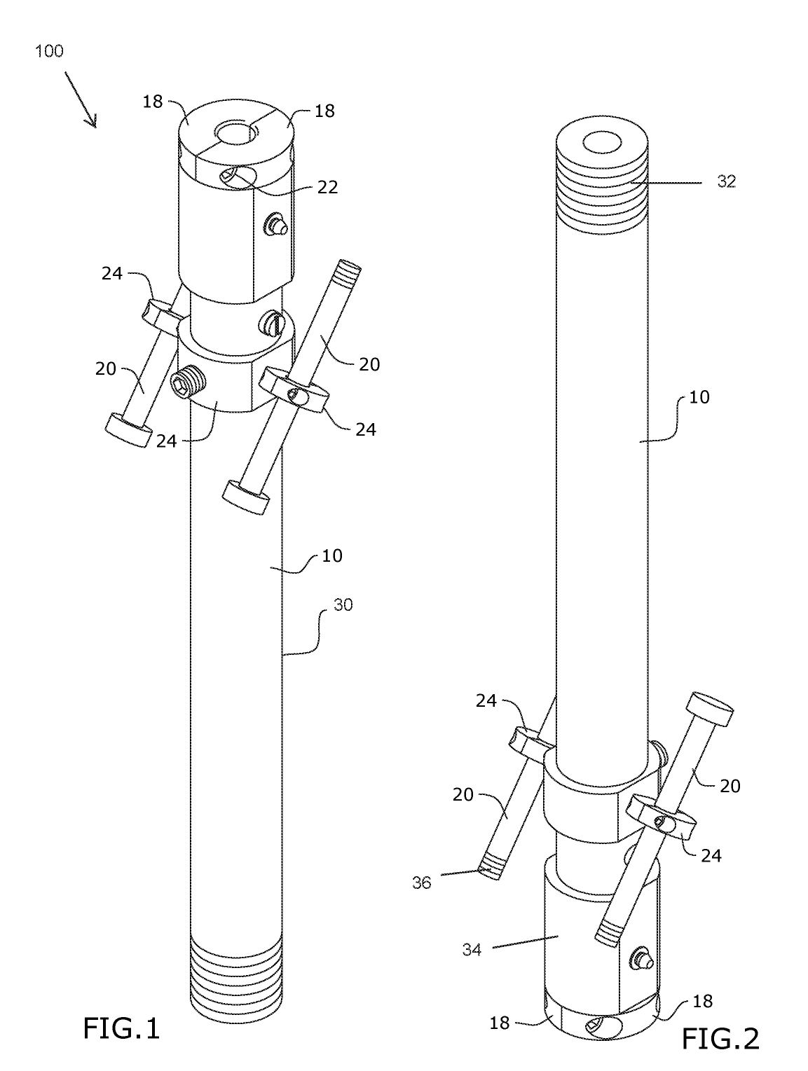

Referring to FIGS. 1 through 3, the present invention may include a valve assembly 100 providing a main housing 10 having an elongated tubular body 30 that extends from a threaded end 32 to a skirt 34. The present invention may be made of stainless steel or any other material of sufficient strength and impermeability. The skirt 34 may provide skirt threading 36 along its internal circumference. The threaded end 32 of the elongated tubular body 30 may be dimensioned and adapted to engage a live gas line (not shown), for example at a shutoff valve (not shown).

Two bushing halves 12 dimensioned and adapted to be joined so as to provide a bushing opening less than said internal circumference of the skirt 34, thereby reducing the effective diameter of said internal circumference when the bushing opening aligns and abuts thereto. The bushing opening ensures a cable (not shown) such as a camera cable is restricted in its side to side movement as it pass through the internal circumference, enabling a proper seal. In certain embodiments, the two pieces of bushing 12 may define an outside diameter of approximately 1.125 inches and an inside diameter of 0.562 inches.

Stacked on the two bushing halves 12 may be a seal 16, providing a seal diameter less than that of the bushing opening diameter. The seal 16 is adapted to seal area between the cable and the bushing opening. The seal 16 may be a gum rubber seal having an approximate 1 inch outside diameter and a 0.55 inch inside diameter, and 0.25 inch thickness.

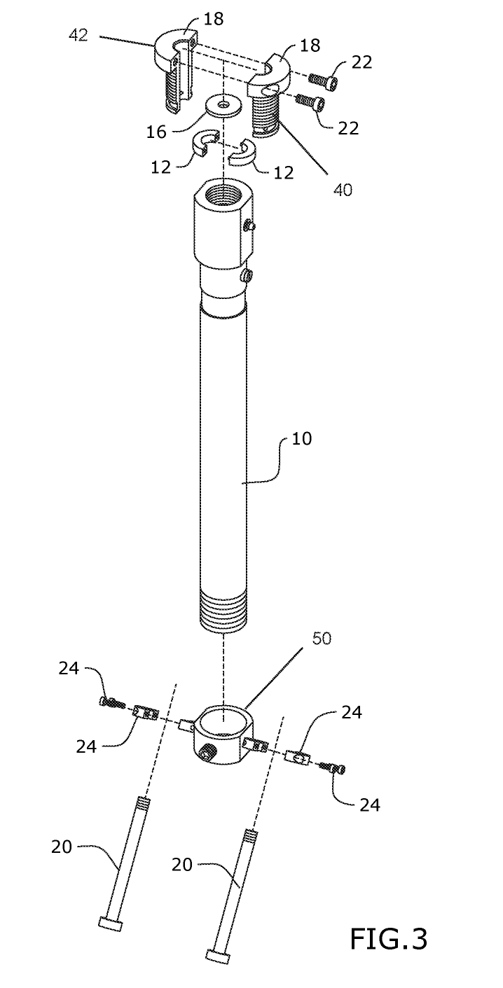

Two adjuster knob halves 18 may each provide a tubular threaded body 40 terminating in a circumferential flange 42 of a greater diameter, as illustrated in FIG. 3. The circumferential flange 42 may provide aligned through holes where fasteners 22 may connect the two adjuster knob halves 18, providing an adjusting seal knob. The threaded body 40 may be adapted to mate into the threaded end 32 of the skirt 34. The two adjuster knob halves 18 enable a user to tighten down on the seal 16, sandwiching said seal 16 so as to prevent any leaks. In certain embodiments, the circumferential flange 42 may be provided with knurled exterior.

The present invention may provide a support collar 50 dimensioned and adapted to slide along the external circumference of the elongated tubular body 30.

The support collar 50 provides opposing brackets 24 for rotatably securing legs 20 with threaded feet 26, wherein the securing legs 20 may be rotated to secure the support collar 50 at a predetermined position along the elongated body 30 of the main housing 10.

A method of using the present invention may include the following. A user may insert the threaded end of the elongated body 30 of the main housing 10 into an opening of a live gas line so that the support collar 50 can be positioned and secured along the elongated body 30 in order to support the main housing 10. The two bushing halves 12 can be joined around cable at the opening of the internal circumference of the skirt 34. Then the seal 16 may be slide over a camera end and down the cable to the connected split bushing 12. Then the cable and camera head can be inserted through the main housing 10 and into the live gas line. The user may manipulate the adjusting seal knob 18 to tighten for making a proper seal. The adjusting seal knob 18 may be clamped around cable with the fasteners 22 screws and then inserted into main housing via the threaded end of the skirt 34 by, for example, turning clockwise, tightening until the seal 16 is secured around cable causing air tight seal.

Thus the present invention allows a user to insert a cable into a live gas line while preventing leakage of the contents of the live line. The present invention may involve bleeding off oxygen to further push the camera cable into the open line, allowing the user to see connections and intersections without purging gas from entire line.

Additionally, the present invention could be used to insert camera into any line or pipe that may need to be sealed from outside elements such as liquid or gas, without allowing the contents of the gas line into the atmosphere.

It should be understood, of course, that the foregoing relates to exemplary embodiments of the invention and that modifications may be made without departing from the spirit and scope of the invention as set forth in the following claims.

What is claimed is:

1. A device, comprising:
an elongated main housing extending from a threaded end to a skirt, wherein the skirt provides a threaded internal circumference;
a bushing providing a bushing opening having a diameter less than a diameter of the threaded internal circumference;
a seal providing a seal opening having a diameter less than the diameter of the bushing opening; and
an adjusting knob providing a threaded body terminating in a circumferential flange, wherein the threaded body is dimensioned to mate with the threaded internal circumference so that the circumferential flange sandwiches the seal against the bushing, while sandwiching the bushing along a periphery of the threaded internal circumference, the seal, bushing, threaded internal circumference and the circumferential flange being concentrically disposed.

2. The device of claim 1, wherein the adjusting knob comprises two joined halves.

3. The device of claim 2, wherein each half of the circumferential flange halves provides aligned through holes.

4. The device of claim 3, further comprising a plurality of fasteners for joining the aligned through holes.

5. The device of claim 1, wherein the bushing comprises two halves.

6. The device of claim 1, further comprising a support collar dimensioned to snugly slide along the elongated body.

7. The device of claim 6, wherein the support collar provides opposing brackets, each bracket rotatably connecting a securing leg to the support collar, wherein rotation of either of the securing legs secures the support collar along the elongated body.

8. The device of claim 7, wherein each securing leg terminates in threading.

9. A device, comprising:
an elongated main housing extending from a threaded end to a skirt, wherein the skirt provides a threaded internal circumference;
a bushing providing a bushing opening having a diameter less than a diameter of the threaded internal circumference, wherein the bushing comprises two halves;
a seal providing a seal opening having a diameter less than the diameter of the bushing opening;
an adjusting knob providing a threaded body terminating in a circumferential flange, wherein the threaded body is dimensioned to mate with the threaded internal circumference so that the circumferential flange sandwiches the seal against the bushing, while sandwiching the bushing along a periphery of the threaded internal circumference, the seal, bushing, threaded internal circumference and the circumferential flange being concentrically disposed,
wherein the adjusting knob comprised two joined halves, and wherein each half of the circumferential flange halves provides aligned through holes;
a plurality of fasteners for joining the aligned through holes; and
a support collar dimensioned to snugly slide along the elongated body, wherein the support collar provides opposing brackets, each bracket rotatably connecting a securing leg to the support collar, wherein rotation of either of the securing legs secures the support collar along the elongated body, and wherein each securing leg terminates in threading.
